(19) United States
(12) Patent Application Publication
(10) Pub. No.: US 2010/0156793 A1
(43) Pub. Date: Jun. 24, 2010

(54) System and Method For An Information Handling System Touchscreen Keyboard

(76) Inventors: Orin M. Ozias, Austin, TX (US); Erin K. Walline, Pflugerville, TX (US)

Correspondence Address: HAMILTON & TERRILE, LLP, P.O. BOX 203518, AUSTIN, TX, 78720, US

(21) Appl. No.: 12/339,264

(22) Filed: Dec. 19, 2008

(51) Int. Cl. G06F 3/02; G06F 3/041

(52) U.S. Cl. 345/168; 345/173

(57) ABSTRACT

An information handling system automatically presents a keyboard input device on a touchscreen display in response to detecting touches on the touchscreen in a keyboard configuration. The location of the keyboard and placement of the keys adapt to an end user's touch, providing a conveniently-sized input device automatically adapted to end user inputs. Haptic feedback at predetermined reference points aids end user interaction with the keyboard.

### BACKGROUND OF THE INVENTION

1. Field of the Invention

The present invention relates in general to the field of information handling system input/output devices, and more particularly to a system and method for an information handling system touchscreen keyboard.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Over time, improvements in technology have allowed increased capabilities by information handling systems with decreased footprint. One example of this trend is the increased capability and reduced size of portable information handling systems. Portable information handling systems have an integrated keyboard, integrated power source, such as a battery, and an integrated display, such as a liquid crystal display (LCD), so that an end user may use the system free from external connections, such as an external power source or external peripherals. The convenience and improved performance of portable information handling systems have led consumers to purchase portable systems as replacements for fixed desktop information handling systems. Consumers tend to tradeoff size versus performance when selecting portable information handling systems. Consumers who travel often tend to seek smaller and lighter systems while consumers who more often use their portable information handling systems for day-to-day office or home operations tend to seek somewhat larger but more powerful systems.

One recent improvement in portable information handling systems is the introduction of systems that have touchscreens in either a conventional clam shell configuration or more recently introduced tablet configurations. The touchscreens not only display information as visible images, but also accept inputs made by an end user touching the screen. As an example, touchscreens are often used to accept inputs at a building directory so that end users can find tenants without having to use a keyboard. As another example, touchscreens are often used in small portable devices, such as handheld music players and cellular telephones. In some instances, touchscreens have integrated haptic devices that provide positive feedback to end users, such as by simulating the feel of a key that is touched by vibrating the area of the touchscreen near what is touched by the end user. Tablet information handling systems have touchscreens that accept end user inputs, such as by receiving and interpreting handwriting done across the screen with a stylus. In some instances, tablet information handling systems present a graphical user interface that an end user touches to input data. For example, a touchscreen can present a standard keyboard as a visual image that accepts end user key inputs. One problem with touchscreen inputs is that the touchscreen typically has a smooth surface that lacks traditional home row locator of conventional keyboards, such as tactile indicators provided by the placement of the “f” and “j” keys. By design, touchscreens typically do not include physical demarcations between projected keyboard keys because touchscreens are also used to present visual images and such demarcations would detract from presentation of visual images.

### SUMMARY OF THE INVENTION

Therefore a need has arisen for a system and method which aids placement of touchscreen images presented to accept end user inputs so that end users can more readily locate the images.

In accordance with the present invention, a system and method are provided which substantially reduce the disadvantages and problems associated with previous methods and systems for placement of touchscreen images that accept end user inputs. A keyboard I/O device automatically presents at a touchscreen display in response to end user touches at the touchscreen in a keyboard configuration.

More specifically, an information handling system has plural processing components that process information and a touchscreen display that presents information as visual images. The touchscreen display also accepts end user inputs made as touches to the display. A keyboard driver operating as firmware on the processing components detects touches made at the touchscreen display in a keyboard configuration. For example, the keyboard configuration may be eight finger touches made across the touchscreen. The keyboard driver aligns a keyboard presented at the touchscreen display so that keys of a keyboard align with finger touches made at the touchscreen. For instance, the letter key “F” aligns with the left hand index finger touch and the letter key “J” aligns with the right hand index finger touch. A haptic feedback is provided at reference keys, such as the “F” and “J” keys, to provide a physical reference for end user placement of typing fingers. The keyboard may lock in place or may adjust to changes in end user finger placement.

The present invention provides a number of important technical advantages. One example of an important technical advantage is that a pop-up keyboard graphical user interface automatically presents at a touchscreen based on an end user's position of hands. The end user is thus able to begin typing with minimal effort and has a keyboard presented with dimensions that match his hand positions. Automatic adaption of keyboard proportions to end user touches provides ease of use even with different anthropometry found across different populations. Different types of keyboards may be presented based on hand position, such as a typing keyboard, a number pad, a mouse pad or an application specific I/O device. A haptic feedback response helps the end user maintain alignment with the keyboard once a keyboard position is automatically generated. The keyboard is locked in place through user settings or may continue to adjust to the end user's position as typing is performed.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a touchscreen display with an automatically presented keyboard; and

FIG. 2 depicts a flow diagram of a process for automatically presenting a keyboard in response to detection of end user touches having a keyboard configuration.

### DETAILED DESCRIPTION

Automatic presentation of a keyboard at a touchscreen of an information handling system in response to touching in a keyboard configuration simplifies end user interaction through touchscreen I/O devices. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

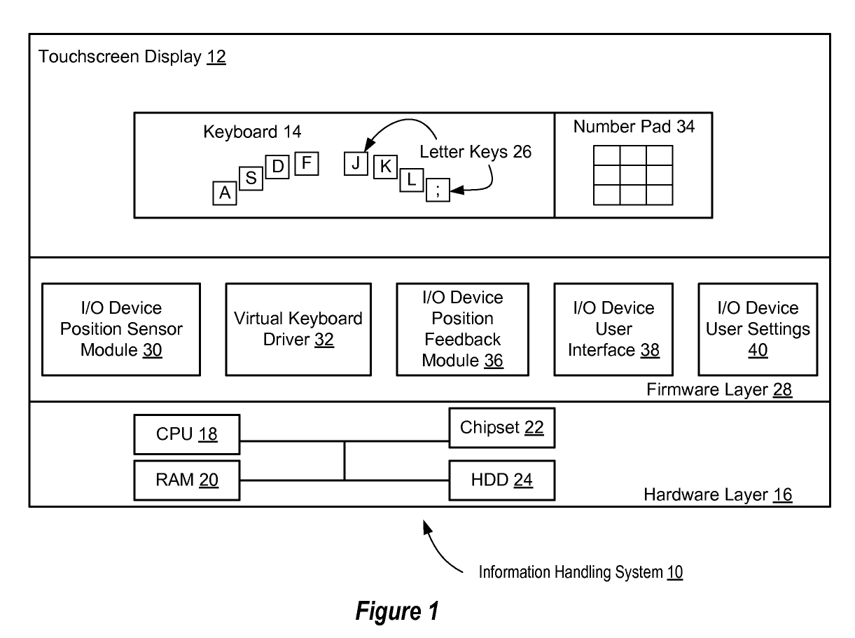

Referring now to FIG. 1, a block diagram depicts an information handling system 10 having a touchscreen display 12 with an automatically presented keyboard 14. Information handling system 10 has a hardware layer 16 that contains a plurality of processing components that cooperate to process information, such as a CPU 18, RAM 20, a chipset 22, and a hard disk drive 24. Display 12 presents processed information as visual images and also detects end user inputs made by touching a pressure sensitive screen. For example, presentation of a keyboard 14 at display 12 as a graphical user interface allows an end user to type at keys 26 in much the same manner as an end user types at a physical keyboard. Keyboard 14 may be varied in presentation, such as with a full keyboard, alpha section only, alpha+number sections, number pad only, or single row as in FIG. 1. The keyboard in FIG. 1 shows only a few characters in an offset alignment as an example of a keyboard image; however, alternative embodiments may have a conventional keyboard adapted to an end user's touch and constraints or settings maintained at the information handling system.

Presentation of keyboard 14 at touchscreen display 12 is managed by firmware running in a firmware layer 28, such as firmware instructions running on an embedded controller or keyboard controller within chipset 22. Keyboard 14 is automatically presented at touchscreen display 12 if end user touches detected by an I/O device position sensor module 30 are determined to have a keyboard configuration by a virtual keyboard driver 32. For example, virtual keyboard driver 32 detects a keyboard configuration if an end user places all eight fingers on the touchscreen at one time. The keyboard configuration maybe determined with other types of touches, such as detection of two finger touches with predetermined spacing between the two fingers, such one to two inches. Alternatively, virtual keyboard driver 32 may differentiate keyboard configurations to present a keyboard with letter keys or a number pad keyboard with number keys. For example, virtual keyboard driver 32 analyzes the length of touches to determine if touches are from one or two hands. If touches are from a single hand then a number pad 34 is presented while touches from two hands results in presentation of a keyboard 14 with letter keys 26. In alternative embodiments, other types of touches can automatically generate other types of virtual I/O devices, such as a mouse pad, or varying configurations of a conventional keyboard. As another example, a 4 or 5-way navigation cluster, such as up, down, left, right arrow keys OR u,d,l,r arrow keys+a center ‘select’ button, is automatically presented at a touch of an end user if a spreadsheet application is presented on the display. Thus, a navigation cluster allows single-step navigation in EXCEL1 when the need to navigate by single cells exists, offering the precision of an on screen tool to assist with specific navigations.

Virtual keyboard driver 32 presents keyboard 14 at a location in touchscreen display 12 based upon the location of the detected keyboard configuration touching. For example, letter keys 26 for the letter “F” and “J” are presented at locations analyzed as touched by an end user's left and right index fingers respectively. The remaining left and right hand reference keys 26 are located based on the spacing detected in the end user's touching in the keyboard configuration. Thus, letter keys 26 having spacing, size and alignment that automatically adjusts to the keyboard configuration touching of an end user. An I/O device position feedback module 36 aids the end user in placement of fingers on reference keys by providing a haptic response at reference keys, such as a slight vibration near the “F” and “J” keys. An I/O device user interface 38 allows the end user to lock a keyboard in a selected location and stores keyboard settings in an I/O device user settings module 40. If keyboard 14 is not locked in place, the location of keys 26 may adjust to accommodate end user movements, such as when an end user lifts fingers from touchscreen display 12 and replaces fingers in a keyboard configuration at a different location. Once keyboard 14 locks in place, a haptic feedback response provides feedback for key presses and a reference location for reference keys. I/O device user interface 38 allows the end user to manually adjust keyboard settings, such a key pitch and feedback in X-axis, Y-axis and radial patterns, as well as selecting presentation of a keyboard with or without number pad 34.

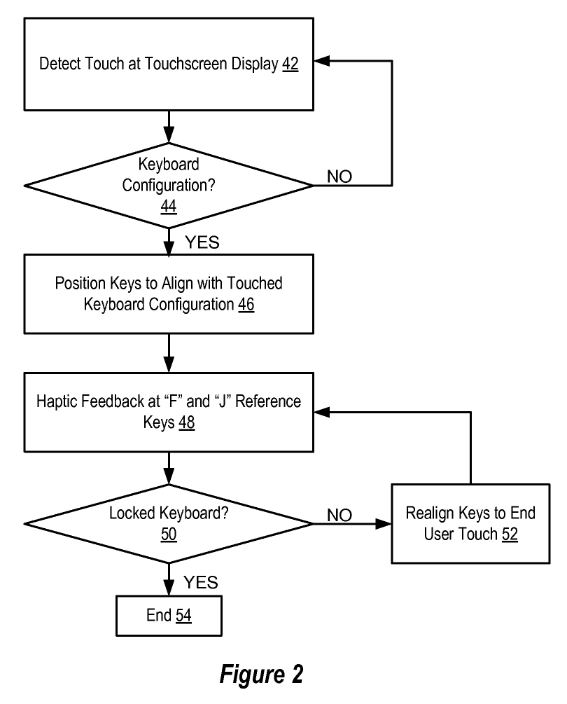

Referring now to FIG. 2, a flow diagram depicts a process for automatically presenting a keyboard in response to detection of end user touches having a keyboard configuration. The process begins at step 42 with detection of touch as the touchscreen display. At step 44, the touch is analyzed to determine if a keyboard configured is present. If not, the process returns to step 42. If a keyboard configuration is detected, the process continues to step 46 to automatically present a keyboard at the touchscreen display with keys positioned to align with touches of the keyboard configuration. For example, the “F” letter key aligns with an end user touch identified as the left index finger and the “J” letter key aligns with an end user touch identified as the right index finger. The remaining keys align with the positions of other touches or based on the proximity to keys with reference touches based on the touched keyboard configuration. At step 50, a determination is made of whether the keyboard is locked in position. If not, the process returns to step 52 to realign keys to changes made in the end user touch. Small or large realignments may be made based upon movements of the end user at the touchscreen display. If the keyboard locks at step 50, the process continues to step 54 to end with the keyboard presented at a locked position until changed by the end user.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to process information;
a display interfaced with the processing components, the display operable to present information as visual images and to accept inputs made by touching an outer surface of the display; and
a keyboard driver running on one or more of the processing components, the keyboard driver operable to detect predetermined touch inputs at the display and in response to the predetermined touch inputs to present a keyboard graphical user interface at the display having keys disposed in a predetermined relationship with the predetermined touch inputs.

2. The information handling system of claim 1 wherein the keyboard driver comprises firmware running on a chipset processing component.

3. The information handling system of claim 1 wherein the predetermined touch inputs comprise plural fingers arranged in a keyboard configuration.

4. The information handling system of claim 1 wherein the predetermined relationship comprises alignment of “f” and “j” keys of the keyboard with touch inputs that correspond to left and right index fingers respectively.

5. The information handling system of claim 1 wherein the predetermined relationship comprises aligning each of plural keys of the keyboard with each of plural touch inputs, the touch inputs associated with end user finger positions.

6. The information handling system of claim 1 wherein the keyboard comprises letter keys.

7. The information handling system of claim 1 wherein the keyboard comprises number keys.

8. The information handling system of claim 1 wherein the keyboard driver is further operable to output a haptic feedback at predetermined positions of the display, the predetermined positions providing reference points for the keyboard.

9. The information handling system of claim 8 wherein the predetermined positions of the display comprise “f” and “j” keys.

10. A method for presenting a keyboard at a touchscreen display, the method comprising:
detecting touch inputs at the touchscreen display;
determining that the touch inputs have a predetermined keyboard configuration; and
automatically presenting a keyboard at the touchscreen display in response to the determining.

11. The method of claim 10 further comprising aligning keys of the keyboard with the touch inputs based upon the predetermined keyboard configuration.

12. The method of claim 11 wherein aligning keys further comprises aligning an “f” key of the keyboard with a touch input corresponding to a user's left index finger and aligning a “j” key of the keyboard with a touch input corresponding to a user's right index finger.

13. The method of claim 10 further comprising providing haptic feedback at one or more predetermined keys of the keyboard.

14. The method of claim 10 further comprising adjusting the location of the keyboard at the touchscreen display by analyzing subsequent touch inputs made at the touchscreen display.

15. The method of claim 10 wherein the keyboard comprises plural letter keys.

16. The method of claim 10 wherein the keyboard comprises plural number keys.

17. A system for presenting a keyboard I/O device at a touchscreen display, the system comprising:
a position sensor module interfaced with the touchscreen and operable to determine positions on the touchscreen touched by an end user; and
a keyboard driver interfaced with the position sensor and operable to detect a keyboard configuration from plural detected touch positions and to present a keyboard at the touchscreen in response to detecting a keyboard configuration.

18. The system of claim 17 wherein the keyboard driver is further operable to place the keyboard on the touchscreen at a location based upon the plural detected touch positions.

19. The system of claim 17 wherein the keyboard comprises plural keys and the keyboard driver is further operable to distribute the keys based upon the plural detected touch positions.

20. The system of claim 17 further comprising a position feedback module operable to provide haptic feedback at one or more keyboard keys in response to touching by an end user.
